(19) United States
(12) Patent Application Publication
(10) Pub. No.: US 2011/0137862 A1
(43) Pub. Date: Jun. 9, 2011

(54) METHOD AND APPARATUS FOR PARALLEL EDIT TO EDITABLE OBJECTS

(75) Inventor: Kunio Kamimura, Tokyo (JP)

(73) Assignee: ATHENA TELECOM LAB, INC., Tokyo (JP)

(21) Appl. No.: 13/024,330

(22) Filed: Feb. 10, 2011

Related U.S. Application Data
(63) Continuation-in-part of application No. 12/864,872, filed on Nov. 18, 2010.

(30) Foreign Application Priority Data
Jun. 12, 2008 (JP) PCT/JP2008/1506
Jul. 1, 2008 (JP) PCT/JP2008/1719

(51) Int. Cl. G06F 17/30

(52) U.S. Cl. 707/624; 707/E17.044

(57) ABSTRACT

Apparatus holds a replica of the original object that is editable by apparatuses equivalent to a computer. The apparatus creates a packet of editorial contents to the replica, send the packet to a server or other apparatuses, and receives a packet of editorial contents to another replica held by another apparatus. The apparatus judges an order of packets by information from a server, and updates the replica by each packet. When apparatuses use same initial replicas, same sequence of packets and same updating procedure, replicas of them synchronize each other on common axis that is a sequence of packets.

### CROSS-REFERENCE TO RELATED APPLICATIONS

This application is a continuation-in-part of U.S. application Ser. No. 12/864,872, which is a U.S. National stage of PCT/JP2009/002491.

The following pending US applications and U.S. designating PCT applications relate to the present application. U.S. application Ser. No. 12/601,005, which is a U.S. National stage of PCT/JP2008/001424. U.S. application Ser. No. 12/688,854, which is a continuation-in-part of PCT/JP2008/001424. U.S. application Ser. No. 12/995,158, which is a U.S. National stage of PCT/JP2009/002490. U.S. application Ser. No. 12/743,367, which is a U.S. National stage of PCT/JP2009/002501. Entire contents of these five U.S. applications that are Ser. Nos. 12/864,872, 12/601,005, 12/688,854, 12/995,158 and 12/743,367 and entire contents of four U.S. designating PCT applications that are PCT/JP2008/001424, PCT/JP2009/002490, PCT/JP2009/002491 and PCT/JP2009/002501 are herein incorporated by reference.

Further, PCT/JP2008/1506 and PCT/JP2008/1719 relate to the present application. Entire contents of these two U.S. designating PCT applications are herein incorporated by reference.

### BACKGROUND OF THE INVENTION

### 1.1 Parallel Edit

Plural computers hold replicas of the original of a computer editable object, such as a database (DB), a file or any editable object. Each computer edits each replica, exchanges editorial information, and updates its replica.

### 1.2 Master-Slave System as Prior Art

### 1.2.1 Technical Outline

Master-slave system is sometimes looked like a parallel edit. Replicas held by slave computers synchronize with the original, because editing work performed to the original of master computer is exactly performed to replicas of slave computers. But it is not parallel edit, because only the master performs edit to the original, as shown by JP2002-244907A.

Master-slave system, in which functionality of master can be moved from a computer to another computer, is described in JP2005-63374 and the following article.
“Evaluation of Replica Management System in Adaptive On-line Storage System” (IPSJ SIG Tech. Rep., 14 Nov. 2002, 2002-AVM-38-6, TOKYO) by Nakamura and others.
   But they are not parallel edit too, because only one computer can be a master at one time.

JP2004-13367A shows a case in which two computers perform editing work separately. As the result, two journals made by these computers will exist. But only one of them is selected, when they re-start synchronization. This is substantially the Master-slave system.

JP2003-122509A describes a procedure of copy from the source to the destination. This is one type of Master-slave system.

### 1.2.2 Problems

If two or more computers were forced to be masters in order to implement the parallel edit, replicas (or plural of the original) do not synchronize each other. For example, assume that computer-A and computer-B edit their replicas separately (in parallel manner) and exchanged their editorial contents (“edit-A” and “edit-B”). Replica of computer-A is updated first by edit-A the next by edit-B. If “edit-A” writes “A” to a record and “edit-B” writes “B” to the record, finally the record will be “B”. The replica of computer-B is updated first by edit-B and next by edit-A. The record of the replica of computer-B will be “A”. Thus, these replicas failed to synchronize each other.

This problem (of synchronization failure) easily occurs, when a computer (or operator) performs editing work for a long time. Because updating its replica by other editing work is stopped, during this editing work. This problem occurs also by delay of transmitting edits by computers. The delay will be extended by re-transmissions, which is caused by congestion of network or noises of communication lines.

These problems are resolved by the present invention. See Section 2.12.1.

### 1.3 Sanwa System as Prior Art

In this specification, “Sanwa system” means the system of JP H03-256146A, in which main and backup center systems of online banking system are separately operated under large-scale disaster.

### 1.3.1 Technical Outline

Each center system makes a journal that is a collection of records with time-stamps of editing work to each replica. During recovery procedure from the disaster, the “main center” merges these journals to one journal, in which records are lined in order of their time-stamps. This journal is used to re-perform edit to the original of the “main center”. After that, replica of the “backup center” synchronizes with the original of the “main center”.

Both centers probably are well equipped, and are operated by trained and reliable persons. The possibility that clocks go wrong or are intentionally manipulated is not so large. The recovery procedure probably is performed correctly and promptly. Thus, this system probably works fine.

### 1.3.2 Problems

But the present invention assumes a different situation. Plural computers can participate in the parallel edit. Any computer can perform an editing work to its replica at any time. When plural computers perform editing work simultaneously, it is a parallel edit. Any computer can send records of editing work to other computers at any time.

If a computer does not send these records for a long time, other computers cannot update their replica by the records for a long time. Even if many records of editing work were gathered to a computer, the computer cannot decide whether all necessary records were collected or not. Furthermore, it is hard to assume that every clock is correct. It is also hard to say there is no possibility that clocks are intentionally manipulated.

These problems are resolved by the present invention. See section 2.12.3.

### SUMMARY OF THE INVENTION

### 2.1 Simplified List of Main Points of the Invention

Before describing details of the present invention, simplified main points of the invention are shown as follows, for easy understandings.

(1) An apparatus holds a replica of the original editable object.
(2) This apparatus creates a packet of editorial contents to this replica.
(3) This packet and other packets that were created by other apparatuses are lined into a sequence by a server or by information provided by the server.
(4) The replica is updated by each packet in the lined order.

Replicas synchronize, when apparatuses use same initial replicas, same sequence of packets and same updating procedure.

### 2.2 Apparatus Equivalent to a Computer

Apparatus described in the claims (and in this specification) is equivalent to any kinds of computers (for example, personal computer, micro-processor, server machine, super computer, etc), cellular phone, smart phone, devices controlled by programs or hardware components, and any other apparatuses equivalent to them. FIG. 1 shows typical structure of a computer. This-apparatus is an apparatus of the invention or an apparatus that performs the method of the invention. Another apparatus is any one of other apparatuses that participates the parallel edit.

Methods of the claims 1-10 will be implemented typically by programs, though they can also be implemented by hardware. These programs are usually recorded in subordinate memory (0105), which are “Hard Disc”, “USB memory”, “Disc”, “SSD” and any kind of “Computer-Readable Non-transitory Medium”. These programs are loaded into Main Memory Unit (0104). As another way, programs can be loaded from another apparatus via Communication Networks (0109) and Communication Unit (0102). FIG. 2 shows functional structure of the computer which has loaded the program of the invention. After that, Arithmetic Unit (0103) of computer (0101) performs methods of the claims. It is also possible to say that the computer is reconfigured as an apparatus of the claims 11-13 by loading the programs. FIG. 3 shows structure of this apparatus.

Related data can be set to the program via Input/output Unit (0106). An operator can see processing status or results of them, via Monitor Unit (0107). These data can be output via Input/output Unit (0106). Usually, these units are connected by Bus (0108).

Some computer has “Computer-Readable Non-transitory Medium” as main memory, in which programs are recorded. These programs are executed directly by the Arithmetic Unit (0103). It is also possible to say that the computer is reconfigured as an apparatus of claims 11-13 by loading the programs. FIG. 2 and FIG. 3 show structures of this kind of apparatus too.

### 2.3 Editable Object

“Editable object” of the invention is an object editable by apparatus defined in section 2.2.

### (1) Database (DB)

DB is an example of the editable object. Relational database and object oriented database are known as functionally well equipped DB. There are many simple DBs, for example, card style DB and any systems that hold data given. Data contained in XML is database, too. XML structure contains item definitions and corresponding data. These item definitions can be easily edited during DB operations.

NoSQL is DB with less restrictions of the relational database. MongoDB, which is one of NoSQL, stores a record consisting of a pair of key and “XML file as a value”. An item definition in the XML file can be changed easily, without considering other records.

### (2) Files

Files (document files, image or motion files, etc) are examples of an editable object. DB contained in (or accompanied with) a file holds data (format, size, etc) that will be used for controlling the file. Data of font and paragraph are recorded closely related with each character or character string of the document. Various kinds of DBs (relational DB, object oriented DB, NoSQL, and DB simply holding information, etc) can be used for this kind of DB for file. The simplest DB is a simple text file that contains a sequence of character codes.

### (3) Structured Data on a Memory

Structured data, which is equivalent to an object of C (or C++) language or of any programming language, is an example of an editable object. When a file is loaded into an apparatus equivalent to a computer, constructed is the structured data on a main memory. Structured data on a main memory can be written into a file or can be sent to other apparatuses equivalent to computers.

### 2.4 Replica

Each apparatus holds a replica of the original editable object, which can be called “globally original editable object”, “editable object” or simply “original”. This specification mainly uses “editable object” or “the original”. The word “replica” is used in the invention, though a phrase of “locally original editable object” was used in U.S. application Ser. No. 12/864,872, of which CIP is this application. Each apparatus creates a packet of editorial contents to each replica. Each apparatus updates each replica by these packets.

A copy of whole of the original can be a replica. Furthermore, a copy of one or more parts of the original can be a replica, too. For example, DB of medical information system contains common information and many parts of individual information, each of which contains medical records for each patient. A computer of a patient holds a replica of his individual information and common information. A computer of a medical doctor holds replicas of his patients, related medical information and common information.

A replica can not only permanently exist, but also temporally exist as a cache, in the apparatus.

### 2.5 Existing or Virtual Editable Object

Each apparatus creates packets of editorial contents to its own replicas (Section 2.7). These packets are lined into a sequence by the server (Section 2.8). Each apparatus updates its replica by these packets in order of the sequence (Section 2.9). When initial contents of these replicas were same, they will have same contents after they are updated by same sequence of packets. Here, apparatuses use exactly same procedure of updating and error handling. Thus, these replicas synchronize each other without existence of the original of editable object. This situation is expressed that each computer has a replica of virtual editable object.

Since each apparatus updates each replica at each convenient occasion, progresses of updating vary in real time. However, replicas are exactly same, if updating them by same sequence of packet had been finished. That is, replicas synchronize each other on common axis that is a sequence of packets.

Empty object (that is object with no contents) can be the initial replica, which can be easily created by computer programs. Of course, any object with contents could be initial object, which should be distributed to apparatuses before the start of “parallel edit”. When an apparatus participate in the parallel edit on the way, there are two possible ways. One is to update the initial object by all packets that already exist, before the participation. Another is to get replica that was already updated by another apparatus, before the participation. This replica will be updated by subsequent packets.

The original can exist and be updated, as if it is one of replicas mentioned above. This situation is expressed that each apparatus has a replica of existing editable object that is the original.

Even if a replica is a copy of one or more parts of the original, this replica can be updated by same packets in order of the sequence (Section 2.9). This replica synchronizes with the corresponding parts of the original, though some packets may not change it. Replicas still synchronize with each other, even if packets changing nothing to a replica of an apparatus are removed from the sequence for the apparatus.

### 2.6 Preamble of Claims

From the above discussions, preamble of claims 1 is:

A method that is performed,
by this-apparatus that is an apparatus holding a this-replica that is a replica of a part or whole of an editable object that is an existing or virtual object editable by apparatuses that are equivalent to a computer,
   to update said this-replica.

The preamble describes a situation which the invention assumed, but does not imply that it is the conventional technology.

### 2.7 Creating a Packet of Editorial Contents

One way of creating a packet of editorial contents is the following. Before making a packet, copy of a replica is created. The replica is treated as local original object and does not be used for temporal editing work. Editing work to the copy is recorded in the packet. Namely, the packet contains journals of the editing work. The replica as local original object will be updated by each packet in the lined order.

As second way, a plan of editing work to the replica can be a packet. A person who creates this kind of packet probably has a copy of the replica in his brain and makes a plan by editing the copy.

As third way, a note of requests of edit to the replica can be a packet, without performing actual edit. When a failure occurs, each computer uses same procedure to handle it. Thus, replicas synchronize each other.

As fourth way, a journal of editing work to the replica which is a local original object can be a packet. There might be a case, in which the replica should be updated by another packet before the editing work for creating the packet, by checking sequence (of packets) determined by the server (section 2.8). If so, the editing work should be cancelled (that is “Rollback”). And the apparatus updates the replica by packets in assigned sequence.

The process (A) of claim 1 is process of creating a packet of editorial contents to the replica, by the ways mentioned above and ways equivalent to them.

### 2.8 Techniques of Setting Sequence of Packets of Editorial Contents

Sequence of packets of editorial contents is determined by a specific apparatus, which is called “server”, by techniques of the following and techniques equivalent to them. “Tx” means “Technique numbered x” for determining the sequence of packets.

2.8.1 Techniques in which Order of Each Packet is Set Directly by the Server

The process (B) of the claim 1 sends the “packet of editorial contents to said this-replica” created by the process (A) to the outside of this-apparatus. As for claim 2, which is according to claim 1, the packet is sent to the server, to which “packet of editorial contents to said this-replica” and “packet of editorial contents to another replica” are brought together. See (2-1) and (2-2) of claim 2. Here, another replica is a replica of a part or whole of the original and is held by another apparatus. See the process (C) of claim 1.

Process (C) receives a packet of editorial contents to another replica. As for claim 2, which is according to claim 1, this packet is received from the server. See item (2-3) of claim 2.

The process (D) judges an order of each packet of a group of packets by information from the server. Here, this group includes “packet of editorial contents to said this-replica” and “packet of editorial contents to another replica”. As for claim 2, which is according to claim 1, the information of the process (D) is an order of the packet, informed by the server.

For setting a sequence of packets by the server, three techniques (T1, T2 and T3) are shown in this specification, which are explained in section 3.1 and FIG. 4.

2.8.2 Techniques in which the Server Assigns Information to Each packet

As for claim 6, which is according to claim 1, the server provides “information that can be used to judge order of packets”, which is assigned to a packet created by the process (A). They are shown by (6-1) and (6-2) of claim 6.

The process (B) sends the “packet of editorial contents to said this-replica” created by the process (A) to the outside of this-apparatus. As for claim 6, the packet is sent to another apparatus. Here, another apparatus holds another replica of a part or whole of the editable object. This is shown by (6-3) of claim 6.

The process (C) receives a packet of editorial contents to another replica. As for claim 6, which is according to claim 1, this packet is received from another apparatus. This is indicated by condition (6-4) of claim 6.

The process (D) judges an order of each packet of a group of packets, by information from the server. As for claim 6, which is according to claim 1, the process (D) is to judge an order (of each packet of said group) according to the information that was set to each packet by the server.

Examples of the information are ordinal number (T4, claim 7), time-stamp (T5, claim 8) and character string (T6, claim 9), which are explained in detail later. Time-stamp or character string (used to determine lexicographic order) is used as a kind of ordinal number. Thus, it is possible to conceive that claim 8 and claim 9 are special case of claim 7.

### 2.9 Updating of Replica

Packets in the sequence are used for updating the replica of this-apparatus by the process (E) of claim 1. That is a process of updating this-replica by each packet of the group, in the order.

### 2.10 Main Points of the Invention

The followings are actions that will be performed by this-apparatus. This-apparatus creates or receives initial replica, for example empty editable object. This-apparatus creates a packet of editorial contents to this-replica held by this-apparatus. Sequence of packets of editorial contents is determined by the server directly or by information assigned to each packet by the server. That is, an order of each packet is determined by information from the server. These packets in the sequence are used for updating this-replica. That is, said this-replica is updated by each said packet, in said order.

Replicas synchronize, when apparatuses use same initial replicas, same sequence of packets and same updating procedure. Progresses of updating these replicas vary in real time, because each apparatus updates each replica at each convenient occasion. However, they are in same status just after these replicas were updated by a specific packet of the sequence. That is, replicas synchronize on axis of the sequence of the packets.

### 2.11 Diagramming of Claims

### 2.11.1 Definitions of Terms

By separating term definitions from descriptions of claims, diagramming of claims will be simple. Term definitions are as follows.

Editable object is an existing or virtual object editable by apparatuses that are equivalent to a computer. This-apparatus is an apparatus that performs method of the claims 1-10, or an apparatus of claims 11-13. This-replica is a replica (held by said this-apparatus) of a part or whole of the editable object. Another apparatus is an apparatus (which is not said this-apparatus) that holds another replica. Another replica is a replica (held by another apparatus) of a part or whole of said editable object. Server (of claims 2-5, 12) is an apparatus to which a “packet of editorial contents to said this-replica” and a “packet of editorial contents to another replica” are brought together. Server (of claims 6-9, 13) is an apparatus assigning “information that can be used to judge order of packets” to each packet.

By using these terms, the claims can be expressed by the following simple phrases. Please note that phrases in FIGS. 2 and 3 were further simplified.

### 2.12.2 Diagramming of Claims 1-10 by FIG. 2

Apparatus (0201) is “this-apparatus” of claim 1-10. Method of one of these claims is to update this-replica (local original object), and is (at least) comprising of processes of (A) (0203), (B) (0204), (C) (0205), (D) (0206) and (E) (0207). These processes are invoked by he “Event dispatcher” (0202), which handles events issued by these processes, other processes (0208) and hardware components (0209).

The process (A) (0203) creates a packet of editorial contents (0212) to this-replica (0214). This packet (0212) is sent to the outside of this-apparatus, via “Communication unit” (0210). As for claim 2, this packet (0212) is sent to the server (0215). If the packet (0212) was recorded in Main or Subordinate memory (0211) at the process (A), there is no need to receive the packet from the server (0215). But, it is also possible (that has not been prohibited) to receive the packet from the server (0215). As for claim 6, this packet (0212) is sent to another apparatus (0216).

The process (C) (0205) receives a “packet of editorial contents to another replica (0218)” from the outside of this-apparatus, via “Communication unit” (0210). As for claim 2, this packet is received from the server (0215). As for claim 6, this packet is received from another apparatus (0216). This packet can be put in “Main or Subordinate memory” (0211).

If the process (A) (0203) of claim 2 did not record the packet into Main or Subordinate memory (0211), the packet should be received from the server (0215). In such a case, the process (C) (0205) of claim 2 should receive the “packet of editorial contents to another replica” and the “packet of editorial contents to this-replica” from the server (0215). These packets can be put in Main or Subordinate memory (0211).

The process (D) (0206) judges an order of each packet of a group (0213) of packets by information from the server (0215). As for claim 2, which is according to claim 1, the information of the process (D) is an order of the packet of the group, informed by the server (0215). As for claim 6, which is according to claim 1, the information of the process (D) is information assigned to each packet by the server (0215).

The process (E) (0207) updates this-replica (0214) by each packet of the group (0213), in the order.

### 2.11.3 Diagramming of claim 11-13 by FIG. 3

Apparatus (0301) is “this-apparatus” of claim 11-13, which updates this-replica (local original object), and is (at least) comprising of means of (A) (0302), (B) (0303), (C) (0304), (D) (0305) and (E) (0306). These means, other means (0307) and hardware components (0308) are connected each other usually by bus (0309) and signals are exchanged among them.

The means (A) (0302) creates a packet of editorial contents (0312) to this-replica (0314). This packet (0312) is sent to the outside of this-apparatus, via “Communication unit” (0310). As for claim 12, this packet (0312) is sent to the server (0315). If the packet (0312) was recorded in Main or Subordinate memory (0311), there is no need to receive the packet from the server (0315). But, it is also possible (that has not been prohibited) to receive the packet from the server (0315). As for claim 13, this packet (0312) is sent to another apparatus (0316).

The means (C) (0304) receives a “packet of editorial contents to another replica (0318)” from the outside of this-apparatus, via “Communication unit” (0210). As for claim 12, this packet is received from the server (0315). As for claim 13, this packet is received from another apparatus (0316). This packet can be put in Main or Subordinate memory (0311).

If the means (A) (0302) of claim 12 did not record the packet into Main or Subordinate memory (0311), the packet should be received from the server (0315). In such a case, the means (C) (0304) of claim 12 should receive the “packet of editorial contents to this-replica” from said server (0315), along with the “packet of editorial contents to another replica”. These packets can be put in Main or Subordinate memory (0311).

The means (D) (0305) judges an order of each packet of a group (0313) of packets by information from the server (0315). As for claim 12, which is according to claim 11, the information of the means (D) is an order of the packet of the group, informed by the server (0315). As for claim 13, which is according to claim 11, the information of the means (D) is information assigned to each packet by the server (0315).

Means (E) (0306) updates this-replica (0314) by each packet of the group (0313), in said order.

### 2.12 Resolution of Problems of the Prior Arts

### 2.12.1 Resolution of Problems of Master-Slave

Master-slave system has a problem that replicas cannot synchronize, if two or more computers were forced to be masters simultaneously. The present invention resolves this problem by setting a sequence of packets of editorial contents. This sequence is used by each apparatus for updating each replica.

### 2.12.2 The Present Invention Cannot be Reached, Even if the Idea of Master-Slave was Developed

In the master-slave system, performances by master are exactly re-performed by slaves. If a performance by master has no failure, slaves never fails at the re-performances.

But, the present invention has different behavior. There might be failures, when replicas are updated by packets of the sequence, even if there were no failures when these packets were created. For example, assume that computer-A had created (without failure) a packet of edit-A. But there is a possibility of a failure when the replica is updated by a sequence consisting of first edit-B and next edit-A, because edit-A was created without thinking of edit-B.

In the master-slave system, only one master can perform editing work at one time period. But, the present invention assumes that plural apparatus can make packets of editorial contents to replicas simultaneously. This is the parallel edits assumed by the invention. The present invention is designed for synchronization of replicas under the parallel edits. On the contrary, the master-slave is designed for implementing exact copy of the original to replicas. Thus, the present invention cannot be reached, even if idea of master-slave was developed, because they have different technical purposes.

### 2.12.3 Resolution of Problems of Sanwa System

When Sanwa system is used under the parallel edit assumed by the present invention, there are problems as described in section 1.3.2.

### (The First Problem)

It is hard to assume that all clocks are correct and were not intentionally manipulated.

### (Resolution by the Present Invention)

Techniques (from T1 to T6) of section 2.8 decide the sequence of packets without using clocks of apparatuses holding replicas. By techniques T1, T2 and T3 (section 2.8.1, section 3.1 and FIG. 4), the sequence of packets is decided directly by the server. No clocks are used by these techniques.

By techniques T4, T5 and T6 (section 2.8.2, section 3.2 and FIG. 5), the sequence of packets is decided by information that was assigned to each packet by the server. Examples shown in this specification was “ordinal numbers”, “time-stamps” and “character strings”. No clocks of apparatuses holding replicas are used by these techniques. Only when “time-stamps” is used, clock of the server is used. It is not difficult to protect clock of the server from intentional manipulations of any other apparatuses. Furthermore, the information assigned to each packet by the server can be enciphered with secret key by the server, in order to prevent intentional manipulations. An apparatus holding replicas decrypts them by the public key and uses them for deciding the sequence of packets.

### (The Second Problem)

A computer cannot detect absence of an editing work that was performed by another computer and was not reached to this computer. Thus, the computer cannot decide whether its replica was correctly updated or not.

### (Resolution by the Present Invention)

When T1, T2 or T3 of section 2.8.1 is used, packets that were left (not sent to server) never exist in the sequence. Any apparatus does not need to consider packets that were not sent to the server. What is necessary is that any apparatus should update its replica by only packets received from the server. If a packet was created in an apparatus, stayed for a long time and was sent to the server later, the packet will be attached to the tail of the sequence and will be used at the last of updating replicas.

When T4 (ordinal number) of section 2.8.2 is used, an apparatus can detect absence of a packet by checking sequence of ordinal numbers. When T5 (time-stamp) or T6 (character string) of section 2.8.2 is used, an apparatus can detect absence of packets if all apparatuses follow the rule that packets should be sent within predefined time from the creation. Packet that was not sent within the predefined time from the creation should be ignored.

### 2.12.4 The Present Invention Cannot be Reached, Even if Idea of Sanwa System was Developed

Sanwa system works fine, if the following conditions are satisfied. Main and backup center systems of online banking system are separately operated only at very rare situation such as large-scale disaster. Both centers are well equipped and are operated by trained and reliable persons. Recovery procedure is performed correctly.

But, the present invention presumes different situations, as follows. Plural number of computers can participate in the parallel edit. Any computer can perform editing work to its replica at any time. This is the parallel edit. Any apparatus can send records of editing work to the server or other apparatuses at any time. Any apparatus can manipulate its clock by any reasons, at any time.

Thus, the present invention cannot be reached, even if idea of Sanwa-system was developed, because they have different situations presumed.

### 2.13 Practical Operations by the Present Invention

### (Substantially Off-Line Operation)

If T1, T2 or T3 (of sections 2.8.1, 3.1 and FIG. 4) is used, the following operation is possible. When treating information of rare competition of edit, packets can be left in an apparatus for a while after the creation. When each section of a company inputs debit slips, this task is not urgent tasks. Even if connection to Internet is impossible, debit slips can be inputted to a local apparatus such as a personal computer, by the present invention. There is no need to send them up to the server immediately, because they will be modified only if mistakes of input or handling are found. It is enough to send them up collectively, becoming near the settlement or inspections of accounts. This operation can be called substantially off-line operation.

(Substantially on-Line Operation)

Though there will be various implementations of procedure of updating replica by packets, it is natural to decide packets based on old information are invalid.

Possible are various implementations of procedure of updating replica by packets. However, it is natural to decide a packet based on newer information is valid, when contents of some packets are conflicting with each other. Packets based on old information are judged non-valid. For lessening a possibility of creating packet to be judged non-valid, the apparatus performs as follows. Before the creation of a packet, the apparatus receives packets to the latest and updates the replica. Next, the apparatus creates a packet of editorial contents to the latest replica, and sends it up to the server immediately. With T1, T2 or T3, it works fine. It can be called substantially on-line operation and is suitable for treating information of high competitions of edit.

### BRIEF DESCRIPTION OF THE DRAWINGS

FIG. 1 shows typical structure of a computer.

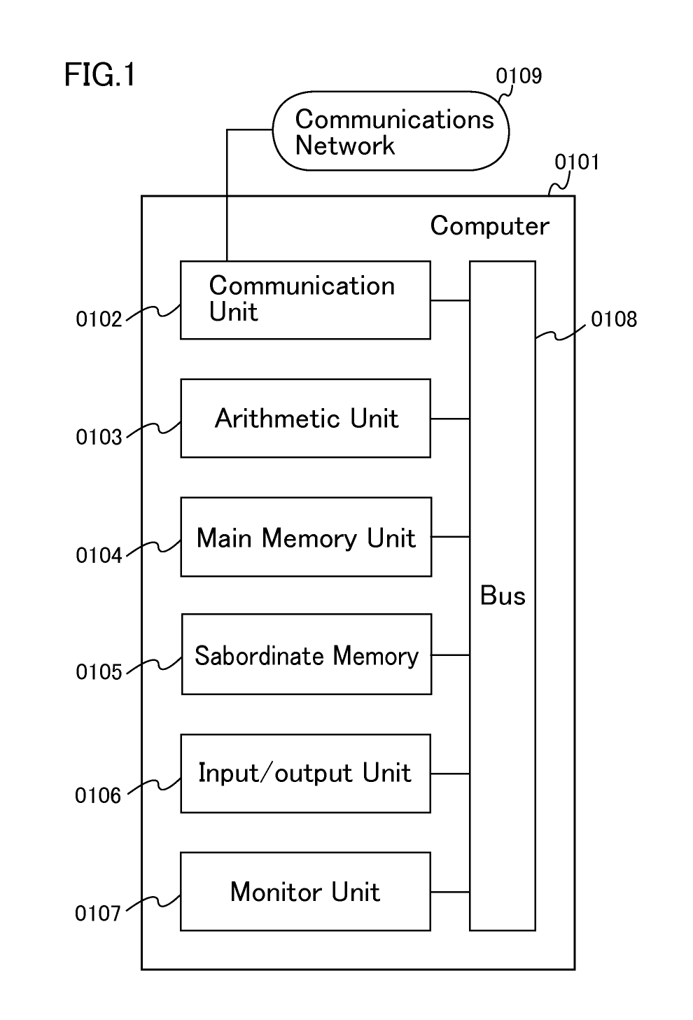

FIG. 2 shows the structure of apparatus performing the methods of claim 1-10.

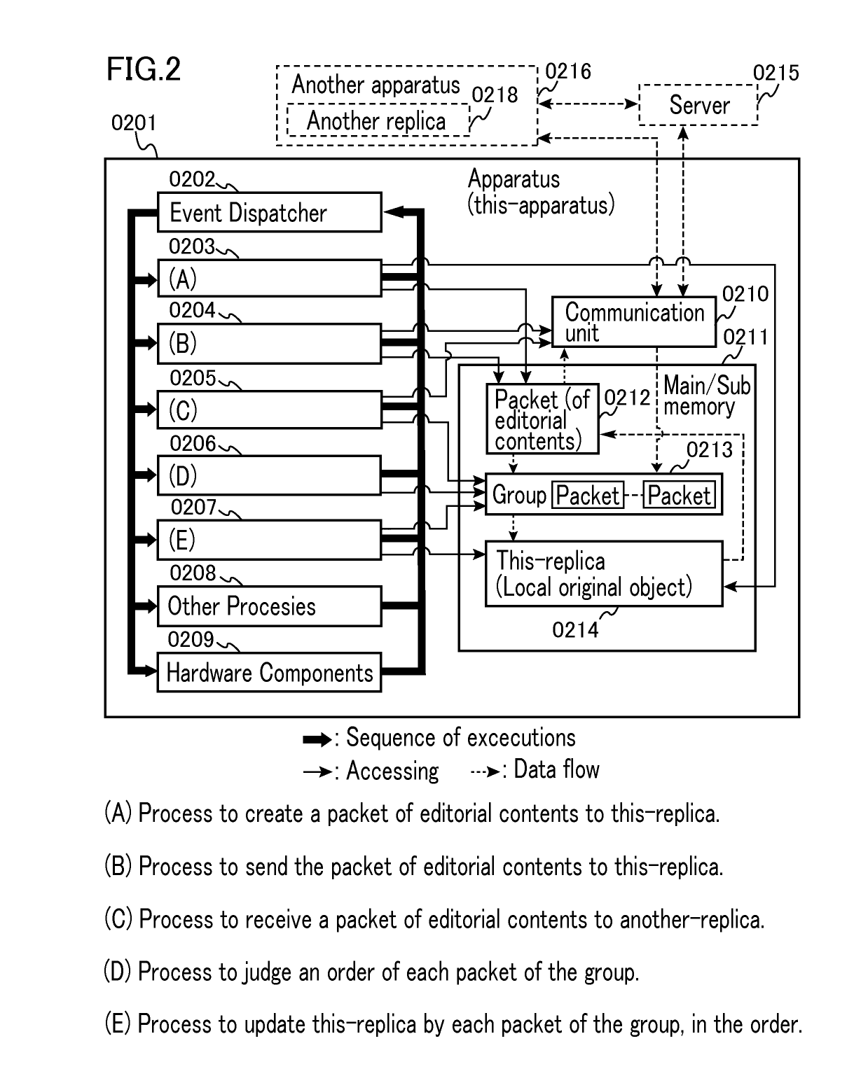

FIG. 3 shows the structure of apparatus implementing claim 11-13.

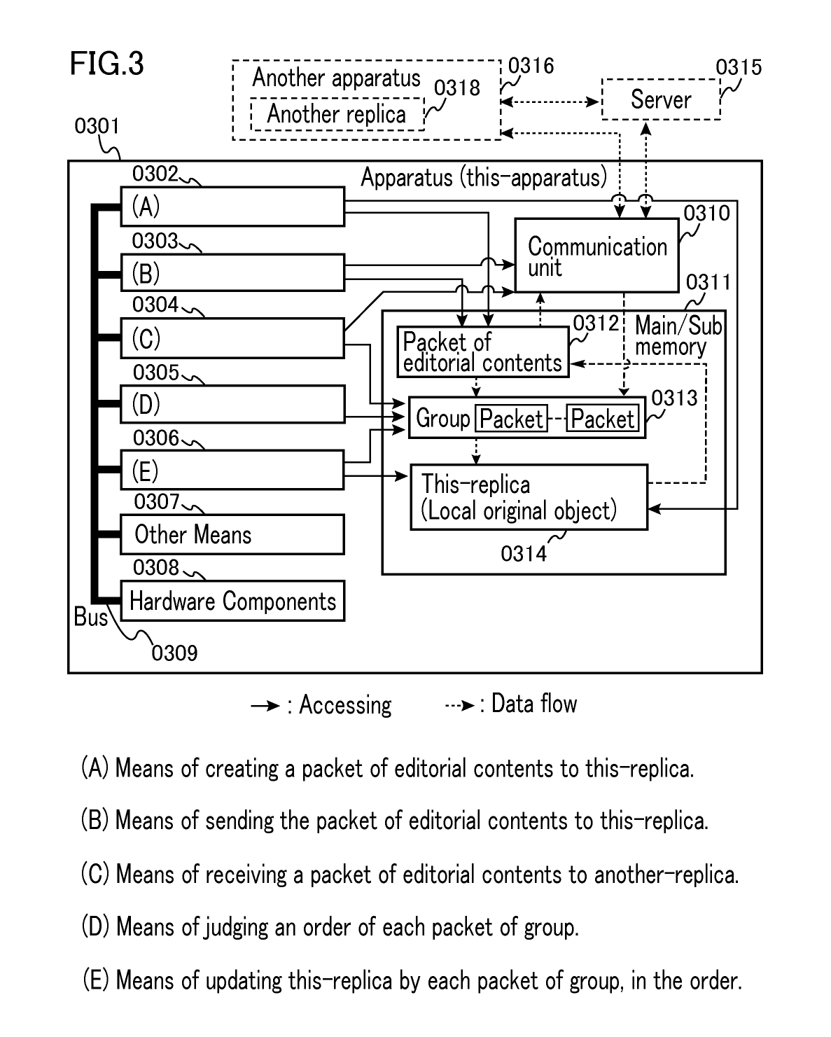

FIG. 4 shows techniques in which order of each packet is set directly by the server.

FIG. 5 shows techniques in which server assigns information (that can be used to judge order of each packet) to each packet.

### DETAILED DESCRIPTION OF THE INVENTION

### 3 Details of Techniques Setting Sequence of Packets

### 3.1 Order of Each Packet is Directly Set by Server

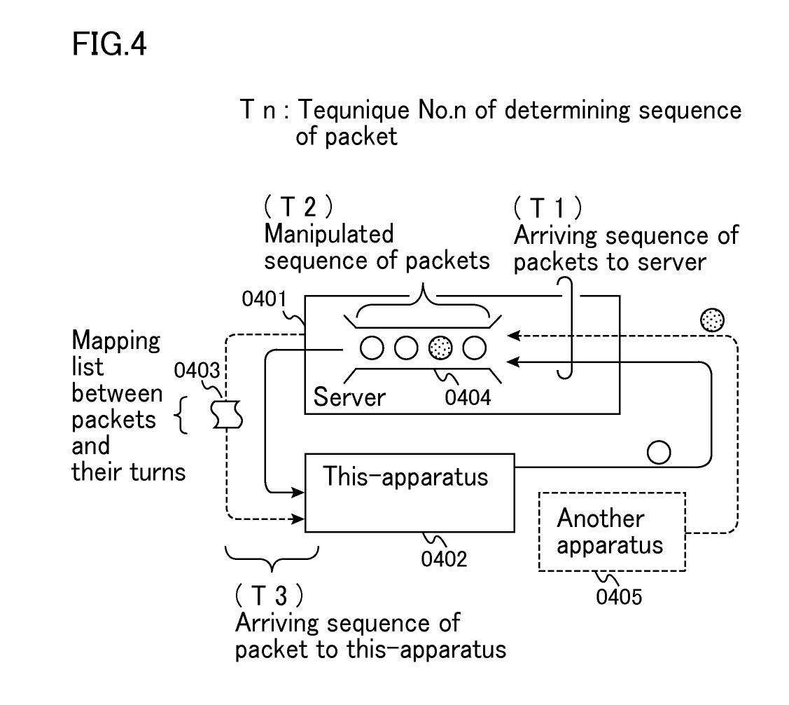

FIG. 4 shows diagramming of T1, T2 and T3. The order set by T1 is an arriving order of packet to the server (0401). FIG. 4 shows a line (0404), which is a sequence of packets that have arrived to the server (0401). Some packets have arrived from this-apparatus (0402) and other packets have arrived from another apparatus (0405).

The line set by T2 is manipulated sequence in the server (0401). Even if the line or packets are manipulated, replicas of apparatus synchronize each other if every apparatus receives same line of same packets. If a packet has erroneous or illegal contents, the server can remove the packet before sending it to an apparatus holding a replica. The server can also remove only erroneous or illegal contents of the packet. Sequence of packets can be changed based on various criteria, such as priority assigned to an operator (who created a packet), importance of edited data, and so on. Claim 4 describes T2, by which packets in the line (0404) are understood as the manipulated sequence.

The sequence set by T3 is an arriving order of packet to this-apparatus (0402). Claim 5 describes T3. Obviously, sequence by T1 or T2 can be informed to this-apparatus (0402) by using T3.

As another method of informing for the sequence to this-apparatus (0402), each packet can include information indicating each order of the sequence. As another method of informing for the sequence to this-apparatus (0402), the server (0401) can send “Mapping list between packets and their turns” (0403) to this-apparatus (0402).

### 3.2 Information that can be Used to Judge Order of Each Packet is Assigned to Each Packet by Server

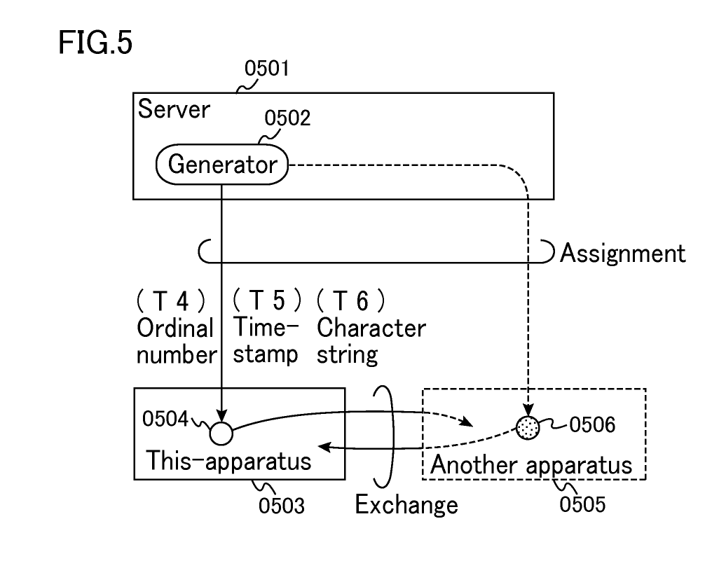

FIG. 5 shows diagramming of T4, T5 and T6. The server (0501) assigns information (generated by the generator 0502) to each packet (0504 or 0506) created by this-apparatus (0503) and another apparatus (0505). T4 (claim 7) uses an ordinal number as “information that can be used to judge order of packets”. T5 (claim 8) uses a time-stamp as “information that can be used to judge order of packets”. T6 (claim 9) uses a character string as “information that can be used to judge order of packets”.

These packets (0504, 0506) are exchanged between this-apparatus (0503) and another apparatus (0505). The sequence of these packets is decided by the information assigned to each packet. As a result, the sequence is decided by ordinal numbers, time-stamps or lexicographic order of character strings.

### 4. Other Information that can be Added to a Packet of Editorial Contents

Packet can include the following information, which will be used for smart updating of replicas. As an alternative way, the server can deliver (to the apparatuses) a list of mapping between packet identifications and the information.

### 4.1 Update Number

Update number can be defined to the original. The related applications that were directly translated into English from PCT applications in Japanese use a word “version”, which means “update number” of this specification. When a word “version” is used in Japanese, it sometimes means “update number”.

A replica of a part or whole of an editable object has update number that is a copy of the update number of the original. When updating the replica by a packet, update number of the replica is increased. Because replicas synchronize each other, updates numbers synchronize too.

When a packet is created, update number of replica is recorded in this packet. The recorded “update number” is called “update number before the editing”, and can be used to judge validity of packets, as shown in section 6.2.

### 4.2 Range of Update Number Control

It is possible to set update number on a set of parts of the original. This set is called “Range of update number control”, which is copied to replicas.

Suppose that the whole DB of medical information is the original. Each lump of medical records for each patient in this DB can be “Range of update number control”. Only when some records of this lump are updated, the corresponding “update number” will be increased.

Setting up of “Range of update number control” depends on structure and contents of information recorded in DB, and needs knowledge of them. For “RDB”, “Range of update number control” can be defined to a set of records, a table, and a group of tables logically related to the table, some specified record among them, or whole of DB.

### 4.3 Range of No-Change to be Confirmed

It is possible to define “Range of no-change to be confirmed” (RNCC) on the original. Replicas have copy of RNCC of the original.

Packet can be linked to one or plural RNCs. This means the following. Packet is judged as non-valid, if some part of RNC was changed before this packet is used to update the replica. If a packet is an editing work to a record of DB, this record can be a RNC, to which this packet is linked. Various setting of RNC and linking with packets are possible.

When the editable object is a relational DB, a record or a table can be a RNC. Further, “whole of DB” or a “group of records and tables that are logically related with each other” can be a RNC. When the editable object is a “structured data on a memory”, “some part of this structure” or “whole of this structure” can be a RNC.

### 5. Process or Means of Sending and Receiving

### 5.1 Receiving Packet, and Receiving an Order of the Packet in the Sequence

### 5.1.1 Claims 2-5 and 12

This-apparatus needs to receive packets created by another apparatus from the server, for executing the present invention of claims 2-5 and 12. If T3 is used or if server informs this-apparatus the information of sequence of T1 or T2 by T3, receiving sequence of packets is the sequence of packets to be used for updating the replica. Thus, it is natural that this-apparatus receives packets created by this-apparatus along with packets created by another apparatus, when T3 is used.

However, it is possible that this-apparatus does not receive packets created by this-apparatus, because this-apparatus can keep these packets after sending them to the server. If so, this-apparatus first confirms an order of a packet created by this-apparatus and skips receiving it from the server. As another way, this-apparatus can receive a “mapping list between packets and their turns” (0403) described in section 3.1 and FIG. 4.

If each packet contains information that was set by the server and that indicates each order of the sequence, this apparatus should receive packets created by this-apparatus from the server.

### 5.1.2 Claims 6-9 and 13

This-apparatus needs to receive packets from another apparatus, for executing the present invention of claims 6-9 and 13. This-apparatus receives “information that can be used to judge order of packets” for a packet created by this-apparatus, from the server. This information is an ordinal number (T4), a time-stamp (T5), a character string (T6), etc. It is natural that this-apparatus write this information into the packet. As another method, server can deliver a list of mapping between “information that can be used to judge order of packets” and packet identification.

### 5.2 Actual Process of Sending and Receiving

Sending and receiving from/to the server or other apparatus means that this-apparatus is sources or destinations and server or other apparatus is destination or source of communication. Between source and destination, there are many intermediate devices such as physical lines, repeaters, switching devices, amplifiers, routers, and so on. The server and another apparatus can be one of these intermediate devices supporting other communications. For example the server can be an intermediate device of a communication between this-apparatus and another apparatus.

### 5.3 Sending and Receiving by Computer Readable Medium

Procedure of sending data can be substituted by writing data to a computer readable medium. Receiving of data can be substituted by reading data from the computer readable media. Computer readable medium is USB memory, Hard Disk, SSD, optical disk such as blue-ray disk, paper, and so on. Printed paper (or paper written by hand) can be read into a computer by scanner, OCR software, etc.

### 6 Details of Updating Replicas

### 6.1 Error Handling

In order to synchronize replicas each other, each apparatus should perform same error handling process. If an error occurs while updating this-replica by a packet, same error occurs while updating another replica of another apparatus. If updating of this-replica by this error making packet is skipped, updating of another replica by this packet is also skipped. Thus, replicas synchronize each other.

As other methods than the method skipping the error-making packet, the following methods are possible. One is to delete error-making parts from the error-making packet and to use it for updating again. Another one is to change the turn assigned to the error-making packet so as not to make errors. No matter what method is employed, each apparatus should perform same error handling process, in order to synchronize replicas each other.

### 6.2 Judgment of Validity of Packet

Before updating a replica by a packet, validity of the packet can be judged. If all apparatus use same criteria of the judgment and use same procedure for handling non-valid packet, replicas synchronize each other.

Examples of the procedure for handling non-valid packet are as follows. First example is to skip updating a replica by the packet judged as non-valid. This is claim 10. Second example is to delete error-making part of the packet. Third example is to change turn assigned to the packet judged as non-valid so as to be judged valid. No matter what method is employed, each apparatus should perform same process for treating non-valid packets, in order to synchronize replicas each other.

“Update number before the editing” described at the end of section 4.1 can be used for judging validity of packets. If two packets of editorial contents conflict each other, packet with the latest “update number before the editing” can be selected. If so, another packet is judged non-valid and is ignored. Any other methods of selecting valid packets can be implemented and will be used with the invention of claim 1. Every replica synchronizes each other, if every apparatus use same method.

### 6.3 Batch Updating

The basic concept of the present invention is to update this-replica by each packet of given sequence. If result of updating is equivalent, some sequence of packets can be merged into one packet and used for updating. When contents of packets have no mutual relations among them, the difference of updating sequence does not affect contents of the replica after all contents of them are used for updating. Thus, contents of such packets can be merged into one packet. Generally saying, contents of packets can be merged, if it does not make replica that is different from replica updated by each packet.

### 6.4 Changing Sequence of Packets by Individual Apparatus

Even if sequence of packets is changed only by a specific apparatus, it is acceptable when result of this updating is equivalent to the result of updating by normal sequence.

### 6.5 Cancelling of Updating Replica Already Performed

If a packet that was already used for updating is judged non-valid, updating by the packet should be cancelled, as shown U.S. application Ser. No. 12/995,158 (PCT/JP2009/002490).

For example, suppose the following. Packet (Y) was first judged non-valid, because the packet conflicts with another packet (X) that was already used for updating. But detailed investigations show that Y should be valid and X must be non-valid. If so, the updating by packet (X) should be cancelled.

Obviously, packets already used for updating should be kept for this cancelling process, which may be invoked later. Updating work by packet X and later packets will be cancelled by roll-back functions. If replicas before updating by each packet have been kept, the replica before updated by X will be used for updating by packets from next of X to Y.

### 7 Examples of Parallel Edit

### 7.1 DB

DB is a example of editable object.

### 7.1.1 Parallel Edit of NoSQL

One of NoSQL is MongoDB, of which each record contains item definitions and data. Data and item definitions can be added to a record by editing work of MongoDB. Data and item definitions of a record can be modified or deleted by editing work of MongoDB. Such editing work to these records does not affect data and item definitions of other record.

Editing work to records of MongoDB will be packed to a packet of the present invention. Packets are lined into a sequence by information from the server and used to update replicas by the methods (or means) of the present invention.

### 7.1.2 Parallel Edit of Data Record of Relational DB

Edit of data record of Relational DB is to add (or modify, or delete) data record. For example, computer-A and computer-B create packets (Packet-A, Packet-B) of adding records. When the sequence is defined as Packet-A and Packet-B, replicas are first updated by Packet-A, and updated by Packet-B next. If there is no conflict among them, these two records are added to both replicas.

### 7.1.3 Edit of Item Definitions

When typical database (for example relational DB) is used, items of record are first defined before records are input. Packets of editorial contents are lined in a sequence and are used for updating replicas by the present invention. If data items are changed, structure of existing records should be changed according to this changing. If a failure occurs at this time, same failure occurs at all replicas. Because every apparatus apply same procedure to handle these failures, as shown in section 6.1, replicas synchronize each other.

For example, computer-A creates packet-A of deleting a data item. Computer-B creates packet-B of adding a record. When the sequence is packet-B and packet-A, replicas are first updated by packet-B (that is adding a record), and updated by packet-A (that is deleting data item) next. When the data item is deleted, structure of existing records will be changed according to this deletion. When the sequence is packet-A and packet-B, replicas are first updated by packet-A (that is deleting an item). A failure will occur when replicas are updated by packet-B (that is adding a record), because the deleted data item still exists in the added record. This updating will be cancelled, and the record of packet-B will never be added into any replica. Replicas synchronize each other at this situation. If every apparatus use process that ignores item definitions that are already deleted and uses only existing item definitions of newly added record, no failures will occur and the record of packet-B will be added into every replica. Replicas synchronize each other at this situation.

For another example, computer-A creates packet-A of adding a data item. If every apparatus use process of setting default value to missing item of record newly added, no failures will occur. Replicas synchronize each other at this situation.

Replicas synchronize each other, if every apparatus uses same procedures.

### 7.1.4 Edit of References

As an example, suppose the following situation. There is a main table “MT” (which is destination of reference from a record of subordinate table) containing records of “Head Office Premises” and “Head Management Section” and names of other organizations of a company. A data item of records of subordinate table “ST” refers a record of MT. Suppose someone decided to unify “Head Office Premises” and “Head Management Section”. He makes a packet of editorial contents including the followings;

(1) To add new record named “Head Office” to MT.
(2) To set “changing reference information” (CRI) to the record named “Head Office Premises”.
(3) To set same CRI to the record named “Head Management Section”.
These CRIs indicate the new record named “Head Office” as the new destination of reference. After replicas are updated by the packet successfully, each MT has the new record named “Head Office”. Each MT also has records named “Head Office Premises” and “Head Management Section” with the CRIs.

When a record (X) of ST is accessed and the data item referring a record of MT is accessed, referenced record of MT is checked whether it has CRI or not. If CRI that indicates “Head Office” exists, reference from X is changed so as to point the record of “Head Office”. This change will be packed to another packet.

I claim:

1. A method that is performed,
by this-apparatus that is an apparatus holding a this-replica that is a replica of a part or whole of an editable object that is an existing or virtual object editable by apparatuses that are equivalent to a computer,
to update said this-replica, comprising,
(A) a process to create a packet of editorial contents to said this-replica,
(B) a process to send said packet to the outside of said this-apparatus,
(C) a process to receive a packet of editorial contents to another replica
that is a replica of a part or whole of said editable object and
that is held by another apparatus,
(D) a process to judge an order of each packet of a group of packets of editorial contents,
which contains said packet of the process (A) and said packet of the process (C),
by information from a server that is an apparatus, and
(E) a process to update said this-replica by each said packet of said group, in said order.

2. A method that is further characterized by the followings, according to claim 1,
(2-1) said server is an apparatus to which said packet of the process (A) and said packet of the process (C) are brought together,
(2-2) said packet of the process (A) is sent to said server,
(2-3) said packet of the process (C) is received from said server, and
(2-4) the information of the process (D) is an order of said packet of said group, informed by said server.

3. A method that is further characterized by the following, according to claim 2,
said order of (2-4) is an arriving order of each said packet to said server.

4. A method that is further characterized by the following, according to claim 2,
said order of (2-4) is an order that was set to each said packet on said server.

5. A method that is further characterized by the following, according to claim 2,
said order of (2-4) is an arriving order of each said packet to said this-apparatus.

6. A method that is further characterized by the followings, according to claim 1,
(6-1) said server is apparatus providing information that can be used to judge order of each said packet of said group,
(6-2) said information of (6-1) is assigned to each said packet,
(6-3) said packet of the process (B) to which said information of (6-1) was assigned is sent to another apparatus,
(6-4) said packet of the process (C) is received from another apparatus, and
(6-5) the information of (6-1) assigned to each said packet is used as the information of the process (D).

7. A method that is further characterized by the followings, according to claim 6,
the information of (6-1) is an ordinal number.

8. A method that is further characterized by the followings, according to claim 6,
the information of (6-1) is a time stamp.

9. A method that is further characterized by the followings, according to claim 6,
the information of (6-1) is a string of characters.

10. A method that is further characterized by the followings, according to claim 1,
said this-replica is not updated by a no-valid packet of the group.

11. This-apparatus,
that is an apparatus holding this-replica that is a replica of a part or whole of an editable object that is an existing or virtual object editable by apparatuses that are equivalent to a computer, and
that performs updating of said this-replica, comprising,
(A) means of creating a packet of editorial contents to said this-replica,
(B) means of sending said packet to the outside of said this-apparatus,
(C) means of receiving a packet of editorial contents to another replica
that is a replica of a part or whole of said editable object and
that is held by another apparatus,
(D) means of judging an order of each packet of a group of packets of editorial contents,
which contains said packet of the means (A) and said packet of the means (C),
by information from a server that is an apparatus, and
(E) means of updating said this-replica by each said packet of said group, in said order.

12. Apparatus that is further characterized by the followings, according to claim 11,
(12-1) said server is an apparatus to which said packet of the means (A) and said packet of the means (C) are brought together,
(12-2) said packet of the means (A) is sent to said server,
(12-3) said packet of the means (C) is received from said server, and
(12-4) the information of the means (D) is an order of said packet of said group, informed by said server.

13. Apparatus that is further characterized by the followings, according to claim 11,
(13-1) said server is an apparatus that provide information that can be used to judge order of each said packet of said group,
(13-2) said information of (13-1) is assigned to each said packet,
(13-3) said packet of the means (B) to which said information of (6-1) was assigned is sent to another apparatus,
(13-4) said packet of the means (C) is received from another apparatus, and
(13-5) the information of (6-1) assigned to each said packet is used as the information of the means (D).
